(19) United States
(12) Patent Application Publication
(10) Pub. No.: US 2006/0287923 A1
(43) Pub. Date: Dec. 21, 2006

(54) Service point management system

(76) Inventors: John Watson, Shropshire (GB); Peter Williams, Wores (GB)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 10/541,643

(22) PCT Filed: Jan. 6, 2003
(86) PCT No.: PCT/GB03/00010

§ 371 Date: Jun. 5, 2006

(51) Int. Cl. G06Q 30/00; G06Q 50/00

(52) U.S. Cl. 705/15

(57) ABSTRACT

A service point management system includes an integrated queue management system and counter weighing apparatus. Both the queue management system and the weighing apparatus are linked to a store management system.

This invention relates to a counter service or Point of Sale management system.

Queue management systems are used in a number of retail establishments to control the flow of customers through a checkout position or service counter. The systems generally comprise a customer display which is provided in a highly visible position and a control device. Each of the checkout positions or service positions all have an assistant operable control which is linked to the control device. A customer will take a ticket from a ticket-dispensing device which will bear a number. When an assistant at a checkout position or service counter is free to deal with a customer then they will operate the assistant operable control which will cause the display of the next customer number to be served, on the customer display. The advantage of such a system is that it enables the efficient management of the flow of customers to checkout or customer service positions. Furthermore, the control device can provide to the retailer information concerning the speed with which customers are dealt with at each checkout position or service counter and also the average time which a customer has to wait prior to being served. In some retail establishments, several such queuing systems are provided at different locations in the store and in these circumstances each control device associated with each queuing system may be linked directly or indirectly to a central information control device which receives the information from each system and processes this in accordance with the retailer's requirements.

It is also quite usual in retail establishments to have weighing apparatus to weigh goods being purchased by a customer. This is normally the case where goods are purchased by weight and the price is per unit of weight. Weighing apparatus which is known for use in this environment will also be capable of storing the quantity and type of goods purchased by each customer and this information is transmitted to a central information storage system where the information is used for stock management and for the generation of retail trends and other statistical data. The weighing apparatus may also incorporate a customer display upon which promotional goods perhaps at discounted prices can be brought to the attention of customers waiting to be served.

The present invention is based upon the realisation that considerable advantage can be obtained by providing a service point management system which integrates both a queue management system and a counter terminal.

Thus and in accordance with the present invention, there is provided a service point management system comprising a customer display device linked to a control device and at least one assistant operable control, said assistant operable control being operable to provide which, upon actuation thereof, an indication on said display device of the next customer to be served, said system further including weighing apparatus which is linked to said control device.

With this arrangement it is possible to provide a service point system in which control of the flow of customers to and from checkout or customer service positions is controlled efficiently and further allows the integration of all management data provided both by the queuing system and also the weighing apparatus providing the retailer with the considerable benefits obtained from processing of this data. Specific management information, derived from the integration of queuing data and the detailed sales data, including identification of the relationship between various queue-related parameters and their sales outcomes. This allows predictive reports on the likely number of customers arriving at the counter and required staffing for each segment of the day. This information may be presented to the counter staff, on the colour display of the counter terminal, in tabular or graphical format.

Preferably, the control device is incorporated within said weighing apparatus and in these circumstances a further data storage and processing device may be provided adjacent to or remote from the control device. Alternatively, the control device may be provided separately from said weighing apparatus.

Preferably, two display devices are provided, one for displaying information as to the next customer to be served and the other display providing information relating to promotional goods or other material at the retailers option. Alternatively, more than two display devices may be provided as desired or as appropriate.

The system may include a device which provides each customer with a queue number and this device may comprise a stand alone supply of sequentially numbered tickets or preferably comprises a device which allocates a sequential queue number to successive customers and prints out these details on to a ticket which the customer retains, the device being linked to the management system. The linking of the device to the management system allows for example promotional information to be stored in the control device and this can be updated as and when required. Therefore, this information can be printed onto the customer ticket along with the customer number. Furthermore, if the device is linked to the system this enables real time processing of information regarding each customer for example how long they wait between taking a ticket and arriving at the checkout or customer service position.

The integration of queue system and counter terminal also allows the provision of a real-time staff alert system, which is capable of identifying variations between the specified “ideal” wait time and queue length, and the actual wait time being experienced by customers. An alert system may be provided, which may be integral with the system, and this may be operable to display this variance to counter or store staff, either by means of a visual alert on the or a display, or by way of an electronic message being sent to a store management system which may or may not form part of the control device and/or data storage and processing device. This message may be proprietary in type, may be sent via electronic mail or may conform to standards such as SNMP.

The invention will now be described further by way of example only and with reference to the accompanying drawings, the single FIGURE of which shows a schematic representation of one embodiment of service point management system in accordance with the present invention.

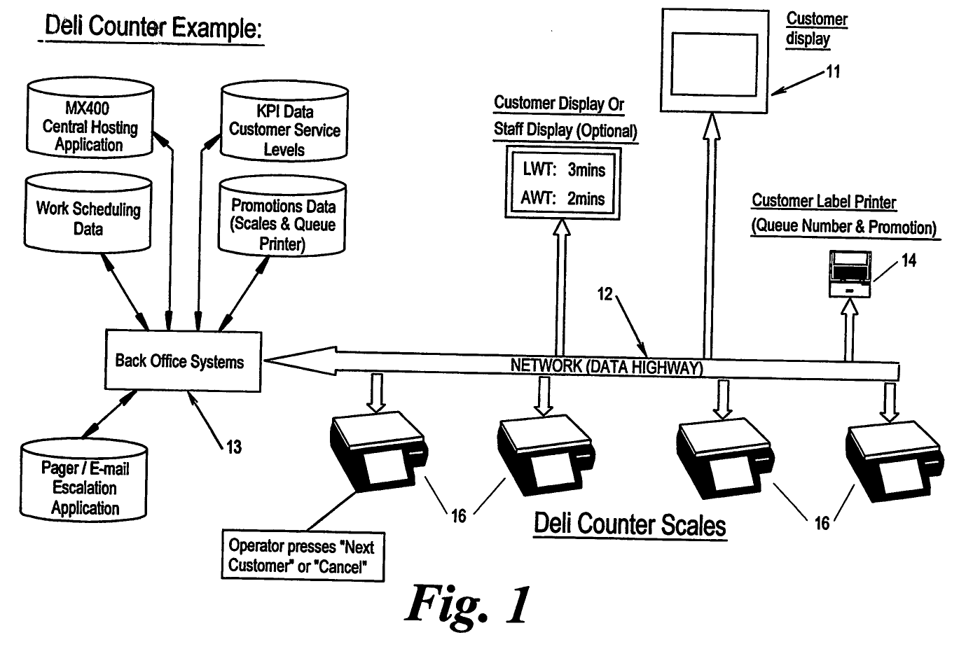

The service point management system shown in FIG. 1 comprises a customer display 11 linked via a data network 12 to an information and a data collection and processing system 13. A customer number allocation device 14 and a plurality of weighing apparatus 16 are also linked to the data network 12.

Whilst four weighing apparatus 16 are shown in the FIGURE, it will be appreciated that as few or as many weighing apparatus as is required for the particular retail establishment, or position within retail establishment, can be utilised.

The customer display 11 comprises any suitable form of display and may be for example an LED or LCD display.

The customer number allocation device 14 includes a suitable printer which upon actuation by a customer allows the printing of a ticket bearing a customer number and any other material as desired or as appropriate.

The data collection and processing device 13 comprises a computer or computer board system.

End weighing apparatus 16 comprises apparatus which is operable to weigh goods which are purchased on a price per weight basis. The weighing apparatus 16 includes operator controls which allow the input of data into the weighing machine of the customer number of the customer being served and the type of goods being purchased.

The data network 12 comprises any suitable network connection which allows the transmission of data between the devices connected to the network. Thus for example, the network may comprise a physical link between the various components or alternatively may comprise a wireless link.

In use, service point management system will be provided at a suitable position within a retail establishment for example delicatessen counter. A customer who wishes to purchase goods on a price per weight basis, will firstly actuate the customer number allocation device 14 which will provide them with a customer number. The display device will provide a display of information including, at the appropriate time, the customer number of the next customer to be served and any other information such as promotional goods which the retailer wishes to bring to the customers attention. The ticket provided by the customer number allocation device 14 to the customer may also include promotional or other information under the control of the control device 13.

Once the customer has received their customer number, the customer waits until the display 11 provides an indication that a customer assistant is free to serve that customer. This will for example be in the form of the customer number for that customer being displayed on the display 11 along with the service position which is free to serve that customer.

Each of the service positions includes a weighing apparatus 16 and when the customer has selected those goods which they desire to purchase these are weighed by the assistant on the weighing apparatus 16. The weighing apparatus 16 preferably includes a printer which prints a self adhesive label bearing the price calculated by the weighing apparatus 16 on the basis of the measured weight of the goods being bought and be stored price per weight. This label is applied to the goods and taken by the customer. At the same time as the weighing apparatus 16 is weighing the goods and calculating the price to be charged to the customer, the information concerning the type of goods being bought and the quantity of goods being bought along with the price being paid is transmitted by the weighing apparatus 16 along the data network 12 to the control device 13. Furthermore, when serving a customer, the assistant will confirm the customer number being served into the weighing apparatus 16 and this will also be transmitted along the data network 12 to the control device 13. Since the time when the customer actuated the customer number allocation device 14 and the time when the assistant confirmed the customer number into the weighing apparatus 16 is monitored, the waiting time for that particular customer can be calculated. Furthermore, since the nature and quantity of goods being purchased is provided to the control device 13, accurate stock management can be undertaken. Also, as the price being charged to the customer is monitored, an accurate assessment of takings by each assistant can be taken.

Once the customer has completed all the purchases that they might wish to make, the assistant enters into the weighing apparatus 16 that the customer has finished being served, or that the assistant is ready to serve another customer. Similarly, if the customer does not respond to his being called, this is so called “No Show” is logged and used in the management reports. In any case, this will allow monitoring of the time it takes to serve customers. This will give an indication of efficiency of operation of staff. Further more, once the weighing apparatus 16 has sent a message to the control device 13 via the data network indicating that the customer has left that service position, this automatically causes the control device 13 to display on the display apparatus 11 the next customer to be served and an indication of the position which is free.

It will be realised that the point of sale management system of the present invention offers a great number of advantages over existing systems. For example, it is possible to generate considerably more information relating to the customer waiting time, serving time, transaction value, nature and quantity of products sold which means that once this information has been processed, considerably greater amount of retail management information is available to the retailer. Furthermore, as most weighing apparatus 16 are now intelligent it is possible to provide a system in which greater information is provided to maximise counter sales and minimise staffing costs. This management system can also preferably include predictive staff schedule reports and real-time alerts when preset queue parameters are exceeded.

Due to the level of integration, the system consists of a reduced number of component parts compared to the use of separate queuing and weighing systems.

It is of course to be understood that invention is not intended to be restricted to the details of the above embodiment which is described by way of example only.

Thus for example, the weighing apparatus may incorporate one or more displays and the apparatus can receive any data whether processed or otherwise from the control device and/or data storage and processing device enabling any of the data collected or generated by the system to be displayed in any suitable form to the assistant. This data may be displayed in real-time if desired.

1-11. (canceled)

12. A service point management system, comprising:
a) a customer display device linked to a control device;
b) at least one assistant operable control operable to provide, upon actuation thereof, an indication on said customer display device of a next customer to be served; and
c) a weighing apparatus which is linked to said at least one assistant operable control.

13. The system according to claim 12, wherein the at least one assistant operable control is incorporated within said weighing apparatus.

14. The system according to claim 13, and a further data storage and processing device provided adjacent to said at least one assistant operable control.

15. The system according to claim 13, and a further data storage processing device provided remote from said at least one assistant operable control.

16. The system according to claim 12, wherein the at least one assistant operable control is provided separately from the weighing apparatus.

17. The system according to claim 12, wherein two customer display devices are provided, one for displaying information as to the next customer to be served, and the other for displaying information relating to promotional goods or other material.

18. The system according to claim 12, wherein more than two customer display devices are provided.

19. The system according to claim 12, and a queue device which provides each customer with a queue number, said queue device being linked to the management system.

20. The system according to claim 19, wherein the queue device comprises sequentially numbered tickets.

21. The system according to claim 19, wherein the queue device allocates a sequential queue number to successive customers and prints out details onto a ticket which the customer retains.

22. The system according to claim 12, further comprising an alert system which provides an indication of a variation between ideal waiting time and queue length relative to an actual waiting time of customers.

23. A service point management system, comprising:
a) a customer display device to display customer information;
b) a customer identifier device to allocate a unique identifier to a customer;
c) at least one weighing apparatus for weighing goods to be purchased by the customer;
d) a data collection and processing means to receive data from at least the at least one weighing apparatus;
e) a data network for linking said customer display device, said customer identifier device, said at least one weighing apparatus, and said data collection and processing means;
f) said weighing apparatus being operable to generate data relating to the customer unique identifier, a quantity and a type of goods being purchased, and a time taken to complete a purchase; and
g) said data being collected and processed by the data collection and processing means to generate processed data comprising stock control and management data, customer queuing data and staff performance data.
